(19) United States
(12) Patent Application Publication
(10) Pub. No.: US 2014/0139066 A1
(43) Pub. Date: May 22, 2014

(54) ROTARY ELECTRIC APPARATUS AND ROTOR

(71) Applicant: KABUSHIKI KAISHA YASKAWA DENKI, Kitakyushu-shi (JP)

(72) Inventors: Hirofumi SHIMONO, Kitakyushu-shi (JP); Seigo ISAYAMA, Kitakyushu-shi (JP)

(73) Assignee: KABUSHIKI KAISHA YASKAWA DENKI, Kitakyushu-shi (JP)

(21) Appl. No.: 14/058,300

(22) Filed: Oct. 21, 2013

(30) Foreign Application Priority Data
Nov. 22, 2012 (JP) 2012-256457

(51) Int. Cl. H02K 3/12

(52) U.S. Cl. CPC H02K 3/12
USPC 310/210

(57) ABSTRACT

A rotary electric apparatus having a stator and a rotor is provided. The rotor includes a rotor core provided with slots extending in an axial direction of the rotor core, and rotor bars arranged in the slots, respectively. The slot and the rotor bar include, in a transverse cross section which is cut perpendicular to a rotation shaft of the rotor, a plurality of convex portions or a plurality of concave portions in at least one of both end faces in a circumferential direction, respectively. The rotor core may further include an outer edge portion extending in the circumferential direction so that it exposes a radially outer portion of the slot and covers the rest.

### CROSS-REFERENCE TO RELATED APPLICATION(S)

The application claims priority under 35 U.S.C. §119 to Japanese Patent Application No. 2012-256457, which is filed on Nov. 22, 2012, the entire disclosure of which is hereby incorporated by reference.

### TECHNICAL FIELD

The present invention relates to a rotary electric apparatus and a rotor.

### BACKGROUND OF THE INVENTION

JP05-078178U discloses a rotor of a rotary electric apparatus (induction motor), in which a plurality of slots are formed to penetrate a core part in an axial direction, without opening through the peripheral surface of the core part, and a plurality of rotor bars are formed in the respective slots by a die-casting process of aluminum or copper, or an alloy thereof.

### SUMMARY OF THE INVENTION

According to one aspect of the invention, a rotary electric apparatus having a stator and a rotor is provided. The rotor includes a rotor core provided with slots extending in an axial direction of the rotor core, and rotor bars arranged in the slots, respectively. The slot and the rotor bar include, in a transverse cross section which is cut perpendicular to a rotation shaft of the rotor, a plurality of convex portions or a plurality of concave portions in at least one of both end faces in a circumferential direction, respectively.

### BRIEF DESCRIPTION OF THE DRAWINGS

The present disclosure is illustrated by way of example and not by way of limitation in the figures of the accompanying drawings, in which the like reference numerals indicate like elements and in which:

FIG. 1 is an axial cross-sectional view schematically showing an entire configuration of a rotary electric apparatus according to one embodiment of the invention;

FIG. 2 is a conceptual transverse cross-sectional view taken along a line A-A of FIG. 1;

FIG. 3 is an enlarged transverse cross-sectional view showing a rotor bar and a slot of a stator core of the rotary electric apparatus;

FIG. 4 is a graph illustrating an improving action of the torque in this embodiment, comparing with a first comparative example where a concavo-convex engaging structure is not provided;

FIGS. 5A and 5B are schematic diagrams showing the behavior of the rotor bar at the time of contraction in a second comparative example where a concave portion and a convex portion are mixedly arranged;

FIGS. 6A and 6B are schematic diagrams showing the behavior of the rotor bar at the time of contraction in this embodiment; and

FIGS. 7A and 7B are schematic diagrams, comparing the behavior of the rotor bar at the time of contraction, between a case where the cross-sectional shape of the concave portion is formed in a curved shape and a case of this embodiment provided with substantially straight sections.

### DETAILED DESCRIPTION

Hereinafter, one embodiment of the present invention is described with reference to the accompanying drawings.

### <Entire Configuration of Rotary Electric Apparatus>

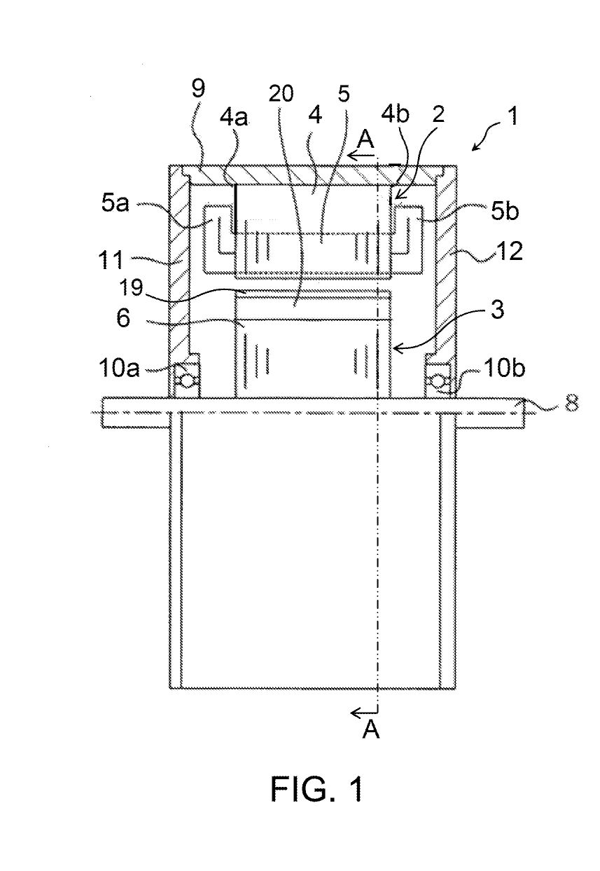

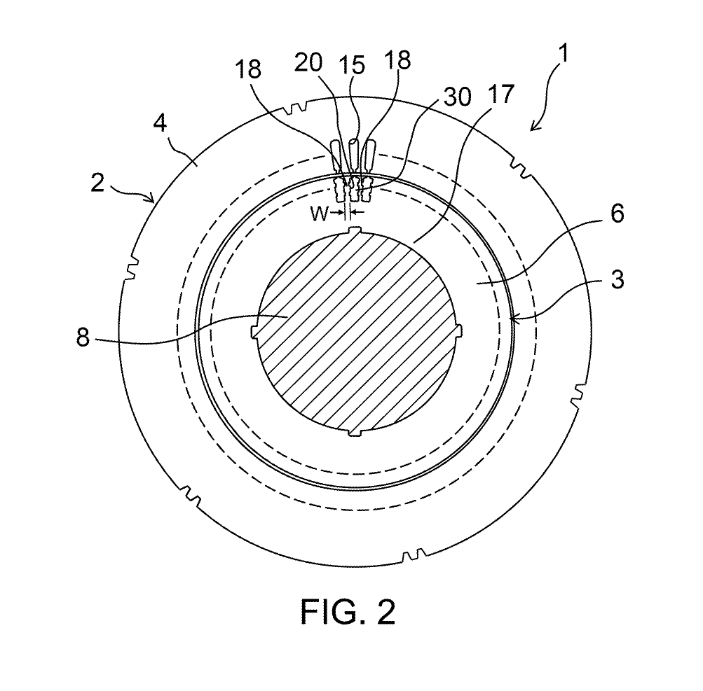

First, an entire configuration of a rotary electric apparatus 1 of this embodiment is described using FIGS. 1 and 2. As shown in FIGS. 1 and 2, the rotary electric apparatus 1 is an induction motor in this example, and includes a substantially cylindrical stator 2 and a substantially cylindrical rotor 3, which are coaxially arranged.

The rotary electric apparatus 1 also includes a substantially cylindrical frame 9, a load-side bracket 11 which blocks one of the openings of the frame 9 in an axial direction (left side in FIG. 1), a no-load side bracket 12 which blocks the other opening of the frame 9 in the axial direction (right side in FIG. 1), and a rotation shaft 8 rotatably supported by the load side bracket 11 and the no-load side bracket 12 via bearings 10a and 10b, respectively.

The stator 2 includes a stator core 4 having a yoke portion and a teeth portion, and fixed by being fitted into an inner circumferential surface of the frame 9, and a stator coil 5 mounted to the teeth portion of the stator core 4. A plurality of slots 15 are formed in a radially inner portion of the stator core 4, penetrating the stator core 4 in the axial direction. The slots 15 are arranged so as to be equally spaced apart from each other in a circumferential direction of the stator core 4. In this example, coil ends 5a and 5b at both ends of the stator coil 5 in the axial direction are bent so that they closely contact with both axial ends 4a and 4b of the stator core 4. Thus, an improvement in heat-conducting characteristics to the stator core 4 of heat generated by the stator coil 5 is achieved. The rotor 3 is fixed to the rotation shaft 8, and arranged inside an inner circumferential surface of the stator 2, having a magnetic gap therebetween.

### <Detailed Configuration of Rotor>

The detailed configuration of the rotor 3 is described using FIGS. 1 to 3. The rotor 3 includes, as shown in FIGS. 1 and 2, a rotor core 6 fixed to the rotation shaft 8, a plurality of slots 20 formed in a radially outer portion of the rotor core 6 and arranged so as to be equally spaced apart from each other in the circumferential direction of the rotor core 6, each slot 20 penetrating the rotor core 6 in the axial direction, and a plurality of rotor bars 30 made of a conducting material and arranged so that they are inserted to fill the plurality of slots 20. In this example, both ends of each rotor bar 30 project from the corresponding slot 20, and the ends of the rotor bars 30 are mutually connected by a short circuit ring (not illustrated) which is integrally provided with the rotor bar 30.

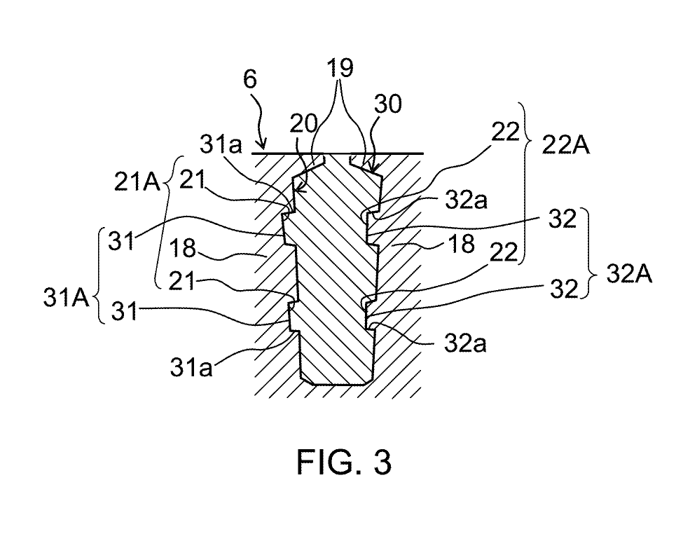

As shown in FIGS. 2 and 3, the rotor core 6 includes a cylindrical coupling portion 17 surrounding the rotation shaft 8, a plurality of teeth 18 formed radially outside the coupling portion 17, equally spaced apart from each other in the circumferential direction and penetrating the rotor core 6 in the axial direction, and a plurality of outer edge portions 19 (shoulder portions) extending in the circumferential direction from the respective teeth 18. Each slot 20 is formed between adjacent teeth 18 of the rotor core 6. Each outer edge portion 19 extends in the circumferential direction from a radially outer portion of each tooth 18 so that it exposes a part of the radially outer portion of the slot 20 (in this example, the center portion of the slot 20 in the circumferential direction) but covers the rest.

The rotor core 6 is made of a suitable metallic material (corresponding to a first metallic material), such as a magnetic steel plate, for example. On the other hand, the rotor bar 30 is made of a suitable metallic material (corresponding to a second metallic material), such as, for example, aluminum, having a linear expansion coefficient greater than to the first metallic material. In order to insert or arrange the rotor bars 30 into the slots 20, respectively, pressurized molten aluminum is forced into the slots 20, i.e., the rotor bar 30 is formed by a die-casting process.

As shown in FIG. 3, each slot 20 and each corresponding rotor bar 30 are constructed in a cross section which is cut perpendicular to the rotation shaft 8 (hereinafter, referred to as “the transverse cross section”) so that at least one of both end faces of the rotor bar 30 in the circumferential direction include a plurality of (a group of) convex portions or concave portions.

In this example, specifically, in the transverse cross section, the rotor bar 30 has a group of convexes 31A in one of the circumferential end faces (in this example, left side). The terms “left” and “right” may be occasionally used hereinafter to indicate the end faces in the cross section. As described above, the group of convexes 31A are comprised of a plurality of (here, two) convex portions 31 (corresponding to a contraction fastening portion in the claims), which are arranged so as to be spaced apart from each other in the radial direction. The rotor bar 30 has a group of concaves 32A in the other end face (in this example, right side in FIG. 3). The group of concaves 32A is comprised of a plurality of (here, two) concave portions 32 (corresponding to the contraction fastening portion in the claims), which are arranged so as to be spaced apart from each other in the radial direction. In this case, the plurality of convex portions 31 which constitute the group of convexes 31A in one end face, and the plurality of the concave portions 32 which constitute the group of concaves 32A in the other end face are located substantially at the same radial locations, respectively.

On the contrary, the slot 20 has, in the transverse cross section, a group of concaves 21A in one of both the circumferential end faces (left side in FIG. 3). The group of concaves 21A is comprised of a plurality of (here, two) concave portions 21 arranged substantially in a radial direction, which engage with the plurality of convex portions 31 of the rotor bar 30 described above, respectively. The slot 20 has a group of convexes 22A in the other circumferential end face (right side in FIG. 3). The group of convexes 22A is comprised of a plurality of (here, two) convex portions 22, which engage with the plurality of the concave portions 32 of rotor bar 30 described above, respectively, and are arranged substantially in a radial direction. In this case, the plurality of concave portions 21 which constitute the group of concaves 21A in one end face, and the plurality of convex portions 22 which constitute the group of convexes 22A in the other end face are located substantially at the same radial locations, respectively.

Each convex portion 31 which constitutes the group of convexes 31A is provided with, in the transverse cross section, two substantially straight sections 31a extending in the circumferential direction. Similarly, each concave portion 32 which constitutes the group of concaves 32A is provided with, in the transverse cross section, two substantially straight sections 32a extending in the circumferential direction.

### <Operations Obtained by Group of Convexes and Group of Concaves>

Next, the operations by the group of convexes 31A and the group of concaves 32A which are provided to the rotary electric apparatus 1 of this embodiment are described in order.

### <Increase in Torque>

As described above, in the rotary electric apparatus 1, the plurality of teeth 18 are provided in the portion of the rotor core 6, which is radially outside from the coupling portion 17. The rotor bars 30 made of the conducting material are insertedly arranged in the slots 20 of the rotor core 6, respectively. Thus, when the rotor 3 rotates, a centrifugal force acts to the rotor bars 30 inside the slots 20 in a radially outer direction. In order to prevent falling-off of the rotor bars 30 from the slots 20 caused by the centrifugal force, the plurality of outer edge portions 19 are formed so as to extend in the circumferential direction from the respective teeth 18. In this case, each outer edge portion 19 can have a higher rigidity if it has a longer circumferential length which covers the portion radially outside the slot 20, and, therefore, the falling-off prevention effect can securely be acquired. However, when the rotary electric apparatus 1 operates, the core loss becomes greater as the circumferential lengths of the outer edge portions 19 are made longer (in other words, each opening through which the slot 20 is exposed is smaller), and, therefore, the efficiency falls.

For this reason, in this embodiment, the plurality of convex portions 31 (in other words, the group of convexes 31A) and the plurality of the concave portions 32 (in other words, the group of concaves 32A) are provided in the circumferential end faces of the rotor bar 30, which is insertedly arranged in the slot 20. Thus, the rotor bar 30 concavo-convex engages with the teeth 19 at the above-described end faces, when the rotor bar 30 is arranged between the teeth 19. As a result, this concavo-convex engagement can achieve the prevention of falling-off of the rotor bar 30 from the slot 20. Therefore, since the circumferential length of the outer edge portion 19 can be made minimum, the core loss can be reduced. Thus, compared with the structure where the falling-off prevention of the rotor bars 30 is achieved only by the outer edge portions 19, larger current can be supplied to the rotor bars 30 and a larger torque of the rotary electric apparatus 1 can be attained.

### <Example of Torque Increase>

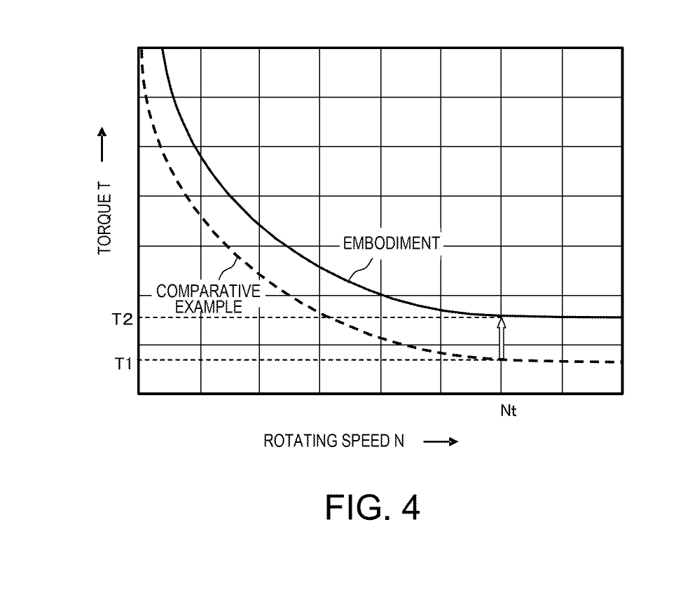

While comparing the above example of the torque increase in the rotary electric apparatus 1 of this embodiment with a comparative example, the torque increase is described using FIG. 4. Here, a first comparative example is in a case where neither the group of convexes 31A nor the group of concaves 32A are provided in the circumferential end faces of the rotor bar 30 which is insertedly arranged in the slot 20, and, instead, the circumferential end faces of the rotor bar 30 are formed in flat faces.

FIG. 4 shows characteristic curves of the rotary electric apparatus, where the horizontal axis indicates a rotating speed N and the vertical axis indicates a torque T. As shown in FIG. 4, both in the first comparative example and this embodiment, the torque T shows behaviors in which it decreases as the rotating speed N of the rotor 3 increases. However, in the first comparative example, in order to achieve the falling-off prevention of the rotor bars 30, it is necessary to comparatively increase the circumferential lengths of the outer edge portions 19 of the stator core 6 from the end faces of the rotor bars 30, and, doing so, the core loss of the rotary electric apparatus 1 at the time of operation becomes large. For this reason, in the first comparative example, it is difficult to supply large current to the rotor bars 30, and, as shown in FIG. 4, the torque T becomes a comparatively low torque T1, for example, at a certain rotating speed Nt.

On the other hand, in the rotary electric apparatus 1 of this embodiment, as described above, the falling-off prevention effect can be acquired by the concavo-convex engagement of the rotor bars 30 with the teeth 18 which use the groups of convexes 31A (or the groups of concaves 32A) in the circumferential end faces. As a result, since the circumferential lengths of the outer edge portions 19 of the stator core 6 are made minimum and magnetic fluxes can be effectively utilized, the core loss at the time of operation can be reduced. For this reason, in this embodiment, since sufficiently large current is supplied to the rotor bars 30, as shown in FIG. 4, the torque T can be increased to a torque T2 which is larger than that of the first comparative example, for example, at the rotating speed Nt.

### <Prevention of Rotor Bar Inclination>

As described above, generally the rotor bars 30 are manufactured by what is called the die-casting process in which the predetermined metallic material in a molten state is pressurized and forced into the slots 20 of the rotor core 6. In this case, as described above, as the metallic material which constitutes the rotor bars 30, a material of which a linear expansion coefficient is greater than that of the metallic material which constitutes the rotor core 6 is used. Therefore, when cooling after the die-casting process, the rotor bars 30 contact with a higher contraction rate than the teeth 18 and the slots 20 of the rotor core 6. For this reason, when carrying out the concavo-convex engagement between the rotor bars 30 and the slots 20, if the convex portions and the concave portions are mixedly formed at the same circumferential end face of the rotor bar 30, there may be a possibility that an inclination of the rotor bar 30 may be caused so that the rotor bar 20 rotates at one of the convex portions (or the concave portions) as a fulcrum because of its contracting behavior.

### <Example of Inclination Behavior>

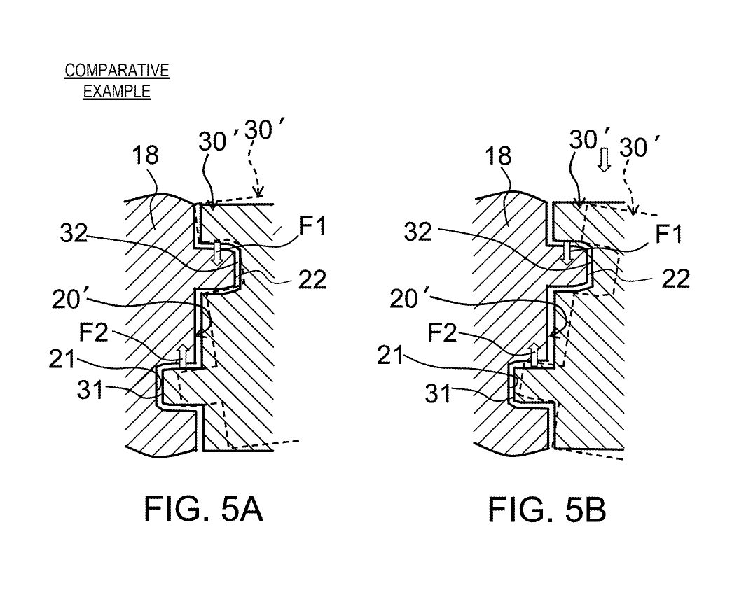

The above inclination behavior is further described using a second comparative example with respect to the above embodiment. Here, as shown in FIGS. 5A and 5B, as for the second comparative example, a case is shown where a convex portion and a concave portion is mixedly formed in the same circumferential end face of a rotor bar 30′ (specifically, one concave portion 32 and one convex portion 31 are formed in this order toward the center of the rotor bar 30′), which corresponds to the rotor bar 30 of the above embodiment. Similarly, in this second comparative example, one convex portion 22 which engages with the concave portion 32 of the rotor bar 30′ and one concave portion 21 which engages with the convex portion 31 of the rotor bar 30′ are formed in the same circumferential end face of the slot 20′, which corresponds to the slot 20 of the above embodiment.

In this second comparative example having the above configuration, if the rotor bar 30′ cools after the die-casting process, the rotor bar 30′ contracts at a higher contraction rate than the teeth 18 and the slots 20′ of the rotor core 6. As a result, as shown in FIGS. 5A and 5B, when the rotor bar 30′ is entirely shrunk, radially shrinking forces F1 and F2 act on a radially outer portion and a radially inner portion of the rotor bar 30′, respectively.

In this case, for example, as shown in FIG. 5A, if the shrinking force F1 in the radially outer portion of the rotor bar 30′ acts before the shrinking force F2 in the radially inner portion of the rotor bar 30′ acts, this does not cause a behavior in which the convex portion 31 presses against the concave portion 21 by the shrinking force F2. Thus, the rotor bar 30′ may rotate counterclockwise at the convex portion 22 as a fulcrum, and the rotor bar 30′ may incline within the slot 20′ (left inclination in FIG. 5A). Alternatively, for example, as shown in FIG. 5B, when the shrinking force F2 in the radially inner portion of the rotor bar 30′ acts before the shrinking force F1 in the radially outer portion of the rotor bar 30′ acts, this does not cause a behavior in which the concave portion 32 presses against the convex portion 22 by the shrinking force F1. Thus, the rotor bar 30′ may rotate clockwise at the concave portion 21 as a fulcrum, and the rotor bar 30′ may incline within the slot 20′ (right inclination in FIG. 5B).

### <Example of Inclination Prevention>

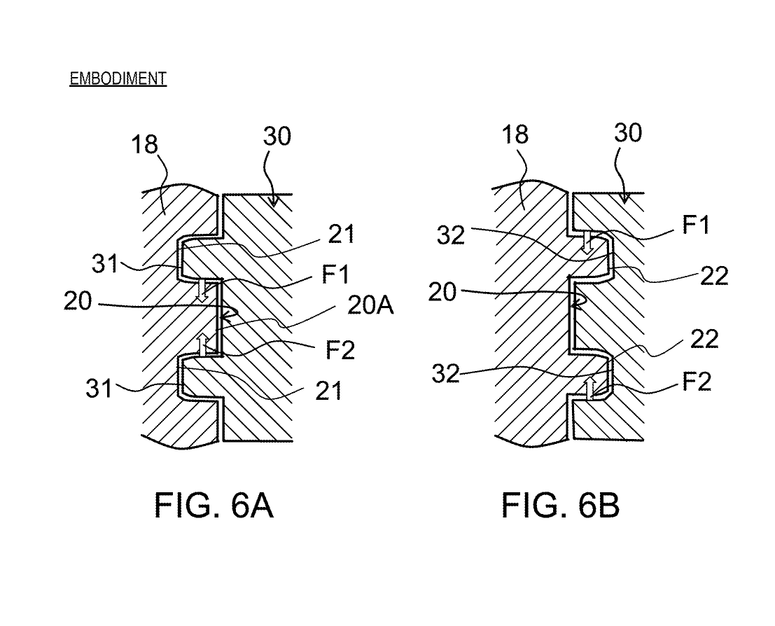

On the other hand, in the rotary electric apparatus 1 of this embodiment, as described above, the group of convexes 31A comprised of the plurality of convex portions 31 (or the group of concaves 32A comprised of the plurality of the concave portions 32) is formed in the same end face of the rotor bar 30, while avoiding the mixed formation of the convex portions 31 and the concave portions 32. The behavior of the rotor bar 30 in the rotary electric apparatus 1 of this embodiment at the time of contraction, having the configuration described above, is schematically illustrated using FIGS. 6A and 6B.

In the example shown in FIG. 6A, two convex portions 31 are formed in the same circumferential end face of the rotor bar 30 so as to be spaced apart from each other in the radial direction. Similarly, the two concave portions 21 which engage with the two convex portions 31 of the rotor bar 30, respectively, are formed in the same circumferential end face of the slot 20 so as to be spaced apart from each other in the radial direction. Thus, when the rotor bar 30 cools after the die-casting process and the rotor bar 30 is entirely shrunk, the shrinking forces F 1 and F2 in the radial direction act from the convex portion 31 located in the radially outer portion (upper side in the drawing) and the convex portion 31 located in the radially inner portion (lower side in the drawing) to the concave portion 21 of the slot 20 which is located between the convex portions 31, respectively. In this case, since, even if there are some offset in acting timings of the shrinking forces F1 and F2 as described above, both the portions are the convex portions, the inclination behavior by rotation like the second comparative example is not caused, but, instead, it turns out to be a behavior in which an area 20A of the slot 20 between these convex portions 31 is squeezed.

In the example shown in FIG. 6B, two concave portions 32 are formed in the same circumferential end face of the rotor bar 30 so as to be spaced apart from each other in the radial direction. Similarly, the two convex portions 22 which engage with the two concave portions 32 of the rotor bar 30, respectively, are formed in the same circumferential end face of the slot 20, so as to be spaced apart from each other in the radial direction. Thus, when the rotor bar 30 cools after the die-casting process and the rotor bar 30 is entirely shrunk, the shrinking forces F1 and F2 in the radial direction act from the concave portion 32 located in the radially outer portion (upper side in the drawing) and the concave portion 32 located in the radially inner portion (lower side in the drawing), respectively. Also in this case, since both the portions are concave portions, even if there are some offset in the acting timing of the shrinking forces F 1 and F2, the inclination behavior by rotation like the second comparative example is not caused, but it turns out to be a behavior in which the shrinking forces F1 and F2 squeezes the convex portions 22, respectively.

As a result, in both the cases of FIGS. 6A and 6B, unlike the second comparative example, the inclination of the rotor bar 30 can be prevented, while the rotor bar 30 can be disposed in the slot 20 in the appropriate state.

### Effects of Embodiment

As described above, according to the rotary electric apparatus 1 of this embodiment, since the magnetic flux can be effectively used by minimizing the circumferential lengths of the outer edge portions 19 of the stator core 6, the core loss can be reduced. Thus, compared with the structure in which the falling-off prevention of the rotor bars 30 is achieved only by the outer edge portions 19, larger current can be supplied to the rotor bars 30. As a result, the torque of the rotary electric apparatus 1 can be increased.

In addition, particularly in this embodiment, each slot 20 and each rotor bar 30 include, in their transverse cross sections, the group of convexes 31A comprised of the plurality of the convex portions 31 in one of the circumferential end faces of each rotor bar 30, and the group of concaves 32A comprised of the plurality of the concave portions 32 in the other circumferential end face. Thus, compared with the case where the group of convexes 31A or the group of concaves 32A is provided only in one of the circumferential end faces of the rotor bar 30, the falling-off prevention effect of the rotor bars by the concavo-convex engaging structure can be further improved.

In addition, particularly in this embodiment, the plurality of convex portions 31 which constitute the group of convexes 31A in one end face of the rotor bar 30 and the plurality of the concave portions 32 which constitute the group of concaves 32A in the other end face are mutually arranged at substantially the same radial location, respectively. Thus, when they are seen in the cross-sectional shape of the rotor bar 30, at a radial location where one of the circumferential ends has the convex portion 31, the other circumferential end has the concave portion 32. Similarly, in the teeth 18 of the stator core 6, the convex portion 22 (corresponding to the concave portion 32 of the rotor bar 30) is formed at the radial location where the concave portion 21 (corresponding to the convex portion 31 of the rotor bar 30) is formed. As a result, a circumferential width W (refer to FIG. 2) of the teeth 18 can be substantially uniform in the radial direction. As a result, the area in the teeth 18 through which the magnetic flux passes can be made uniform and, thus, a magnetic flux density can be made uniform.

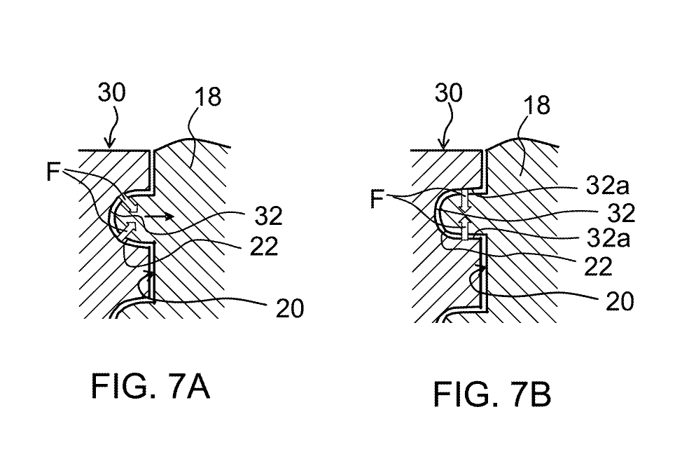

Further, particularly in this embodiment, the transverse cross sections of each convex portion 31 which constitutes the group of convexes 31A and each concave portion 32 which constitutes the group of concaves 32A are provided with substantially straight sections 31a and 32a extending in the circumferential direction. Effects of these substantially straight sections 31a and 32a are described using FIGS. 7A and 7B.

That is, as shown in FIG. 7A, the transverse cross-sectional shape of the concave portion 32 of the rotor bar 30 may also be curved or rounded (in order to eliminate edges from the concave portion 32 and the corresponding convex portion 22). However, in this case, when the rotor bar 30 is contracted, the convex portion 22 is slipped on the curved surface described above due to the shrinking force F acting from the concave portion 32 to the convex portion 22 and, thus, the convex portion 22 is pushed out from the concave portion 32. Therefore, there is a possibility that secure fastening may become impossible.

On the other hand, in this embodiment, as schematically shown in FIG. 7B, the substantially straight sections 32a are formed, instead of the entirely curved shape, in the radially outer portion (upper side in the drawing) and the radially inner portion (lower side in the drawing) of the concave portion 32 of the rotor bar 30, respectively. Thus, by applying the shrinking forces F in the radial direction, from the substantially straight sections 32a of the concave portions 32 to the area 20B of the slot 20 between the straight sections 32a, respectively (in other words, from both upper and lower sides in the drawing), the convex portion 22 can be securely fastened.

Note that, also for the substantially straight sections 31a, the shrinking forces can securely be acted in the radial direction by a similar principle as described above and, thus, the fastening can be ensured.

As a result, when applying the forces in the radial direction from the rotor bar 30 to the concave portions 21 (or the convex portion 22) of the slot 20, caused by the high contraction rate as described above, the concave portions 21 (or the convex portions 22) can be securely fastened. Therefore, the rotor bars 30 can firmly be fixed to the slots 20.

Note that, although the case where the rotary electric apparatus 1 is of an inner rotor type which includes the rotor 3 provided inside the stator 2 is described above as one example, it may also be applicable to a rotary electric apparatus of outer rotor type in which the rotor 3 is provided outside the stator 2. Further, although the case where the rotary electric apparatus 1 is an induction motor is described above as one example, it may also be applicable to other type of electric motors, and to electric generators.

Further, other than described above, the approaches of the above embodiment may be suitably combined.

Further, although not illustrated, various changes may be made to the embodiment described above, without departing from the scope and spirit of the invention.

1. A rotary electric apparatus having a stator and a rotor, the rotor comprising:
a rotor core provided with slots extending in an axial direction of the rotor core; and
rotor bars arranged in the slots, respectively,
wherein the slot and the rotor bar include, in a transverse cross section which is cut perpendicular to a rotation shaft of the rotor, a plurality of convex portions or a plurality of concave portions in at least one of both end faces in a circumferential direction, respectively.

2. The rotary electric apparatus of claim 1, wherein the rotor core further includes an outer edge portion extending in the circumferential direction so that it exposes a radially outer portion of the slot and covers the rest.

3. The rotary electric apparatus of claim 1, wherein the cross-sectional shape of the convex portion or the concave portion in the transverse cross section includes a substantially straight section extending in the circumferential direction.

4. The rotary electric apparatus of claim 1, wherein the slot and the rotor bar include, in the transverse cross section, the convex portion in one of both the end faces in the circumferential direction, and the concave portion in the other end face, respectively.

5. The rotary electric apparatus of claim 4, wherein the plurality of convex portions in the one end face and the plurality of concave portions in the other end face are mutually arranged substantially at the same radial locations, respectively.

6. The rotary electric apparatus of claim 1, wherein the rotor core is made of a first metallic material, and the rotor bar is made of a second metallic material having a larger linear expansion coefficient than the first metallic material.

7. A rotary electric apparatus having a stator and a rotor, the rotor comprising:
a rotor core provided with slots extending in an axial direction of the rotor core; and
rotor bars formed by a die-casting process to fill the slots, respectively,
wherein at least one of both end faces of each of the rotor bars in a circumferential direction has, in a transverse cross section which is cut perpendicular to a rotation shaft of the rotor, a contraction fastening portion for fastening a part of the rotor core, when the rotor bar contracts by cooling after the die-casting process.

8. A rotor, comprising:
a rotor core provided with slots extending in an axial direction of the rotor core; and
rotor bars arranged in the slots, respectively,
wherein the slot and the rotor bar include, in a transverse cross section which is cut perpendicular to a rotation shaft of the rotor, a plurality of convex portions or a plurality of concave portions in at least one of both end faces in a circumferential direction, respectively.

9. A rotor, comprising:
a rotor core provided with slots extending in an axial direction of the rotor core; and
rotor bars formed by a die-casting process to fill the slots, respectively,
wherein at least one of both end faces of each of the rotor bars in a circumferential direction has, in a transverse cross section which is cut perpendicular to a rotation shaft of the rotor, a contraction fastening portion for fastening a part of the rotor core, when the rotor bar contracts by cooling after the die-casting process.
